(19) United States
(12) Patent Application Publication
(10) Pub. No.: US 2024/0167715 A1
(43) Pub. Date: May 23, 2024

(54) SYSTEM AND METHOD FOR SCHEDULING A VARIABLE REFRIGERANT FLOW (VRF) SYSTEM IN ACCORDANCE WITH A PROGRAMMABLE SCHEDULE

(71) Applicant: HONEYWELL INTERNATIONAL INC., Charlotte, NC (US)

(72) Inventors: Nagasree POLURI, Bangalore (IN); Gutha Stalin SANGHAMITRA, Bangalore (IN); FoongYeen CHAN, Petaling Jaya (MY); Barnali CHETIA, Bangalore (IN)

(21) Appl. No.: 18/511,354

(22) Filed: Nov. 16, 2023

(30) Foreign Application Priority Data
Nov. 21, 2022 (IN) 202211066722

(51) Int. Cl. F24F 11/64; F24F 11/58

(52) U.S. Cl. CPC F24F 11/64; F24F 11/58

(57) ABSTRACT

A scheduling system includes a controller executing a schedule engine that is configured to generate one or more scheduled control point values for one or more ODUs and/or one or more IDUs of a VRF system in accordance with the programmable schedule. A gateway is configured to provide a first communication channel between the controller and an I/O interface of the VRF system. The controller is configured to communicate the one or more scheduled control point values to the I/O interface of the VRF system via the gateway. At least one controller of the VRF system receives the one or more scheduled control point values via the I/O interface of the VRF system and controls the at least one ODU and/or the at least one IDU in accordance with the one or more scheduled control point values.

### CROSS-REFERENCE TO RELATED APPLICATIONS

This application claims priority pursuant to 35 U.S.C. 119(a) to Indian Application No. 202211066722, filed Nov. 21, 2022, which application is incorporated herein by reference in its entirety.

### TECHNICAL FIELD

The present disclosure relates generally to variable refrigerant flow (VRF) systems. More particularly, the present disclosure relates to systems and methods for scheduling a VRF system in accordance with a programmable schedule.

### BACKGROUND

Building management systems (BMS), especially for small and medium sized buildings (i.e., like restaurants, supermarkets, and so on) are moving towards ductless, easy to install heating, ventilation and air conditioning (HVAC) systems like variable refrigeration flow (VRF) and variable refrigeration volume (VRV) systems. A VRV system provide a variable refrigerant volume control for heating and cooling spaces in a facility. A VRF involves a variable refrigerant flow system where a compressor or the like may heat or cool the refrigerant in an outdoor unit (IDU), which is then sent to indoor units (IDUs) to condition the air in the building. A variable speed drive may control the compressor, allowing it to regulate and vary the flow of refrigerant. VRF and VRV systems can generally be referred to as VRF systems, and are treated interchangeably in the present description.

The original equipment manufacturers (OEMs) of VRF and VRV systems include companies such as Daikin™, Bluestar™, Mitsubishi™, Hitachi™, and so forth. Such OEM's typically offer control systems along with their mechanical equipment. These control systems often include controllers, input/output devices like sensors, and so on, and tools to configure the same. These control systems tend to work effectively when used at a single site and in conjunction with the corresponding OEM's equipment. However, a problem can arise when it is desirable to integrate such systems within an overall building management system (HVAC, lighting, fire, and so forth) due to their proprietary control systems. Although the OEMs often expose certain control system parameters using open protocols like Modbus™, seamless interoperability of VRF systems with other building management system components can be a challenge.

### SUMMARY

The present disclosure relates generally to variable refrigerant flow (VRF) systems. More particularly, the present disclosure relates to systems and methods for scheduling a VRF system in accordance with a programmable schedule. An example may be found in a scheduling system for controlling a Variable Refrigerant Flow (VRF) system (e.g. VRF and/or VRV system) in accordance with a programmable schedule, wherein the VRF system includes at least one Outdoor Unit (ODU), at least one InDoor Unit (IDU), at least one controller for controlling the at least one ODU and the at least one IDU, and an I/O interface. The scheduling system includes a controller executing a schedule engine, the schedule engine configured to generate one or more scheduled control point values for one or more of the at least one ODU and/or one or more of the at least one IDU of the VRF system in accordance with the programmable schedule. A gateway is configured to provide a first communication channel between the controller and the I/O interface of the VRF system. The controller is configured to communicate the one or more scheduled control point values to the I/O interface of the VRF system via the gateway. One or more of the at least one controller of the VRF system receives the one or more scheduled control point values via the I/O interface of the VRF system and controls the at least one ODU and/or the at least one IDU in accordance with the one or more scheduled control point values.

Another example may be found in a method for scheduling a Variable Refrigerant Flow (VRF) system in accordance with a programmable schedule, wherein the VRF system includes at least one Outdoor Unit (ODU), at least one InDoor Unit (IDU), at least one controller for controlling the at least one ODU and the at least one IDU, and an I/O interface. The method includes executing a schedule engine on a controller, the schedule engine generates one or more scheduled control point values for one or more of the at least one ODU and/or one or more of the at least one IDU of the VRF system in accordance with the programmable schedule. The method includes communicating from the controller the one or more scheduled control point values generated by the schedule engine to the I/O interface of the VRF system via a gateway, receiving at one or more of the at least one controller of the VRF system the one or more scheduled control point values via the I/O interface of the VRF system, and controlling the at least one ODU and/or the at least one IDU in accordance with the one or more scheduled control point values.

Another example may be found in a non-transitory, computer readable medium having instructions stored thereon that when executed by one or more processors, cause the one or more processors to receive one or more scheduled control point values generated by a schedule engine, map each of the one or more scheduled control point values to a corresponding target control point of a VRF system, and communicate the one or more scheduled control point values to the corresponding target control points of the VRF system via an I/O port of the VRF system.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative system for scheduling a VRF system;

FIG. 2 is a flow diagram showing an illustrative method for scheduling a VRF system;

FIG. 3 is a flow diagram showing an illustrative method for scheduling a VRF system;

FIG. 4 is a flow diagram showing an illustrative series of steps that may be carried out by one or more processors executing executable instructions stored on a non-transitory, computer readable medium;

FIG. 5 is a schematic block diagram showing an illustrative system; and

FIGS. 6A through 6D are screen captures showing an illustrative workflow for adding a VRF system;

FIGS. 7A through 7C are screen captures showing an illustrative workflow for adding bulk IDUs of an added VRF system;

FIGS. 8A through 8D are screen captures showing an illustrative workflow for creating groups for IDUs;

FIGS. 9A through 9D are screen captures showing an illustrative workflow for adding IDUs to groups and setting setpoints and schedules for the IDSs; and

FIGS. 10A through 10D are screen captures showing an illustrative workflow for scheduling VRF IDU groups.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

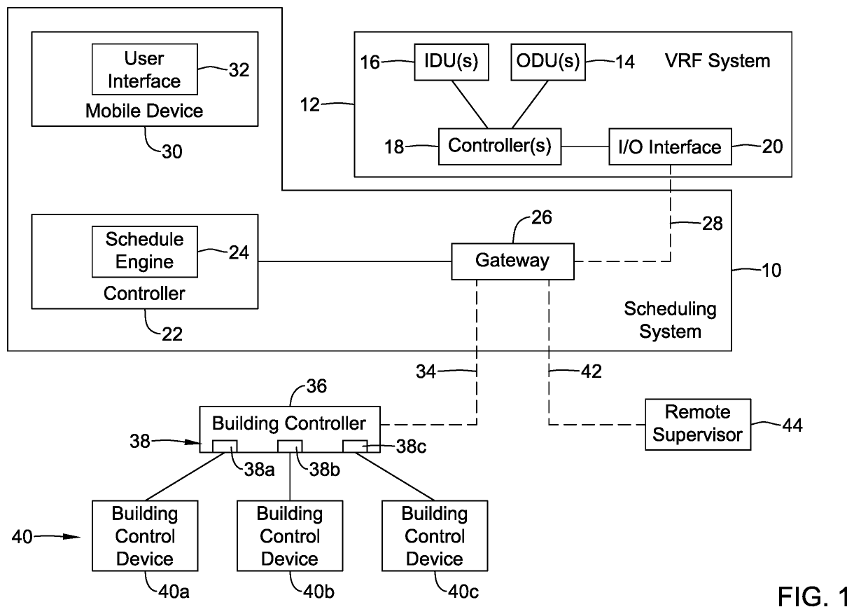

FIG. 1 is a schematic block diagram of an illustrative scheduling system 10. The illustrative scheduling system 10 may be used for controlling a Variable Refrigerant Flow (VRF) system 12 in accordance with a programmable schedule. VRF and VRV systems can generally be referred to as VRF systems, and are treated interchangeably in the present description. In some cases, the VRF system 12 may include at least one Outdoor Unit (ODU) 14 and at least one Indoor Unit (IDU) 16. The VRF system 12 may include at least one controller 18 for controlling the at least one ODU 14 and the at least one IDU 16. The VRF system 12 may include an I/O interface 20 that is operably coupled with the at least one controller 18. In some cases, the VRF system 12 may include a single ODU 14 and a plurality of IDUs 16, for example.

The illustrative scheduling system 10 includes a controller 22 that executes a schedule engine 24. The schedule engine 24 is configured to generate one or more scheduled control point values for one or more of the at least one ODU 14 and/or one or more of the at least one IDU 16 of the VRF system 12 in accordance with the programmable schedule. The scheduled control point values may correspond to any suitable point value, such as a setpoint control point value (e.g. temperature, humidity, flow, volume, etc.) and/or an ON/OFF control point value.

The illustrative scheduling system 10 includes a gateway 26 that is configured to provide a first communication channel 28 between the controller 22 and the I/O interface 20 of the VRF system 12. In some cases, the controller 22 and the gateway 26 are housed in separate housings. In some cases, the controller 22 and the gateway 26 are housed together in a single housing (e.g. in the gateway housing). In some cases, the controller 22 and/or the gateway 26 may be manifested within a unitary controller.

The controller 22 is configured to communicate the one or more scheduled control point values to the I/O interface 20 of the VRF system 12 via the gateway 26. In some cases, one or more of the at least one controller 18 of the VRF system 12 receives the one or more scheduled control point values via the I/O interface 20 of the VRF system 12, and controls the at least one ODU 14 and/or the at least one IDU 16 in accordance with the one or more scheduled control point values. In some cases, the one or more scheduled control point values include one or more of an ON/OFF control point value or a setpoint control point value.

In some cases, the schedule engine 24 may be configured to generate one or more scheduled group control points values for each of two or more groups of ODU's 14 and/or IDU's 16 of the VRF system 12 in accordance with a corresponding group programmable schedule, wherein at least one of the two or more groups include two or more ODU's 14 and/or IDU's 16 of the VRF system 12. In some cases, the controller 22 may be configured to communicate the one or more scheduled group control point values for each of the ODU's 14 and/or IDU's 16 in each of the groups of ODU's 14 and/or IDU's 16 of the VRF system 12 to the I/O interface 20 of the VRF system 12 via the gateway 26. In some cases, the schedule engine 24 of the controller 22 may be configured to receive external inputs provided by one or more building control devices 40, and to use one or more of the external inputs in conjunction with the programmable schedule to generate the one or more scheduled control point values for one or more of the at least one ODU 14 and/or one or more of the at least one IDU 16 of the VRF system 12. In some cases, the controller 22 may include one or more wiring terminals for accepting wires that are configured to be connected to one or more building control devices 40 (e.g. fire sensor).

In some cases, the gateway 26 maps each of the one or more scheduled control point values received from the controller 22 to a corresponding target control point of one or more of the at least one controller 18 of the VRF system 12, and communicates the one or more scheduled control point values to the corresponding target control points. In some cases, the gateway 26 maps each of the one or more scheduled control point values received from the controller 22 to the corresponding target control point of one or more of the at least one controller 18 of the VRF system 12 via point sharing. In some cases, the gateway may reference a mapping template that corresponds to the particular VRF system 12.

In some cases, the scheduling system 10 may further include a mobile device 30 that includes a user interface 32 such as but not limited to a touch screen display, for example. The mobile device 30, which may for example be a tablet, a phablet or a smart phone, may be configured to receive from a user a selection of the VRF system 12 from a plurality of different VRF systems 12 via the user interface 32 of the mobile device 30. The mobile device 30 may be configured to generate a mapping between the one or more scheduled control point values generated by the schedule engine 24 to a corresponding target control point of the I/O interface 20 of the selected VRF system 12. In some cases, the mobile device 30 may be configured to communicate the mapping to the gateway 26.

In some cases, the mobile device 30 may be configured to allow a user to define one or more of two or more groups of ODU's 14 and/or IDU's 16 of the VRF system 12 via the user interface 32 of the mobile device 30. The mobile device 30 may be further configured to communicate the one or more defined groups for use by the schedule engine 24 to identify the corresponding group programmable schedules. In some cases, the mobile device 30 may be configured to allow the user to define a schedule for each of the one or more defined groups via the user interface 32 of the mobile device 30 and to communicate the defined schedule for each of the one or more defined groups for use by the schedule engine 24.

In some cases, the gateway 26 may be configured to establish a second communication channel 34 with a building controller 36. The building controller 36 may include one or more wiring terminals 38, individually labeled as 38a, 38b and 38c, for accepting wires that are configured to be connected to one or more building control devices 40, individually labeled as 40a, 40b and 40c. While schematically shown as three sets of wiring terminals 38, it will be appreciated that the building controller 36 may include any number of wiring terminals 38, and moreover that each of the wiring terminals 38 may represent a connection for one wire, connections for two wires, three wires or more, for example. In some cases, the controller 22, which is part of the scheduling system 10, may actually be housed by the building controller 36. The building control devices 40 may each include, for example, one or more of an HVAC component, a lighting component, a fire system component and a sensor.

In some cases, the gateway 26 may be configured to establish a third communication channel 42 with a remote supervisor 44. In some cases, the third communication channel 42 may include the Internet, and the gateway 26 may be configured to receive changes to the programmable schedule from the remote supervisor 44 over the third communication channel 42. The remote supervisor may be any suitable computing device.

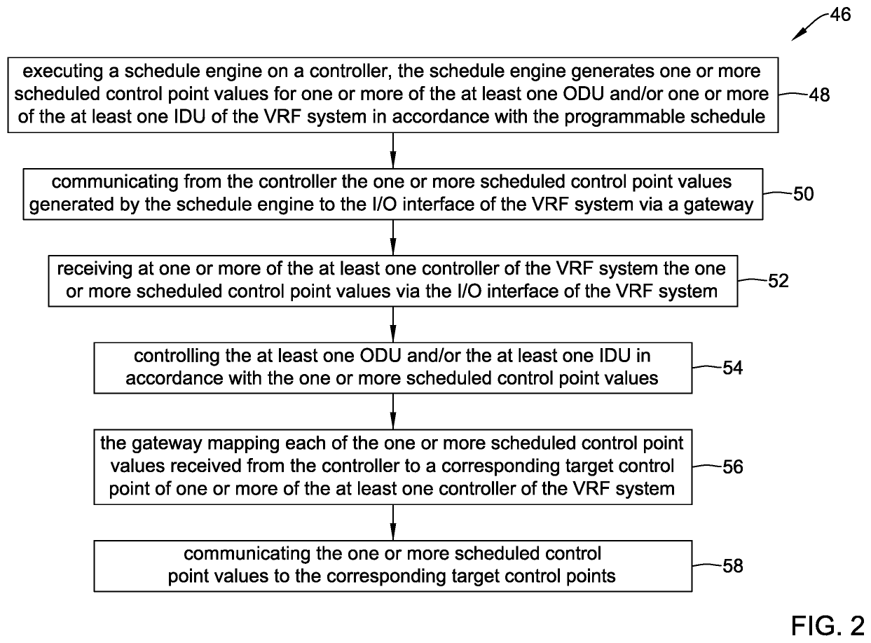

FIG. 2 is a flow diagram showing an illustrative method 46 for scheduling a Variable Refrigerant Flow (VRF) system (such as the VRF system 12) in accordance with a programmable schedule, wherein the VRF system includes at least one Outdoor Unit (ODU), at least one Indoor Unit (IDU), at least one controller for controlling the at least one ODU and the at least one IDU, and an I/O interface. The method 46 includes executing a schedule engine on a controller, the schedule engine generates one or more scheduled control point values for one or more of the at least one ODU and/or one or more of the at least one IDU of the VRF system in accordance with the programmable schedule, as indicated at block 48. The method 46 includes communicating from the controller the one or more scheduled control point values generated by the schedule engine to the I/O interface of the VRF system via a gateway, as indicated at block 50. The method 46 includes receiving at one or more of the at least one controller of the VRF system the one or more scheduled control point values via the I/O interface of the VRF system, as indicated at block 52. The at least one ODU and/or the at least one IDU are controlled in accordance with the one or more scheduled control point values, as indicated at block 54.

In some cases, the method 46 may include the gateway mapping each of the one or more scheduled control point values received from the controller to a corresponding target control point of one or more of the at least one controller of the VRF system, as indicated at block 56. The one or more scheduled control point values may be communicated to the corresponding target control points, as indicated at block 58. In some cases, the gateway maps each of the one or more scheduled control point values received from the controller to the corresponding target control point of one or more of the at least one controller of the VRF system via point sharing.

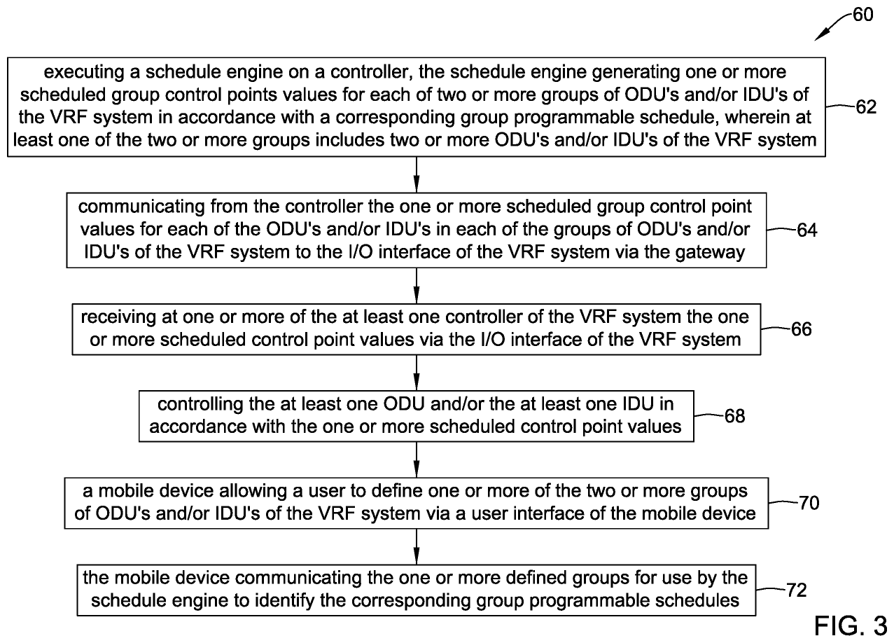

FIG. 3 is a flow diagram showing an illustrative method 60 for scheduling a Variable Refrigerant Flow (VRF) system (such as the VRF system 12) in accordance with a programmable schedule, wherein the VRF system includes at least one Outdoor Unit (ODU), at least one Indoor Unit (IDU), at least one controller for controlling the at least one ODU and the at least one IDU, and an I/O interface. The method 60 includes executing a schedule engine on a controller, the schedule engine generating one or more scheduled group control points values for each of two or more groups of ODU's and/or IDU's of the VRF system in accordance with a corresponding group programmable schedule, wherein at least one of the two or more groups comprise two or more ODU's and/or IDU's of the VRF system, as indicated at block 62. The method 60 includes the controller communicating the one or more scheduled group control point values for each of the ODU's and/or IDU's in each of the groups of ODU's and/or IDU's of the VRF system to the I/O interface of the VRF system via the gateway, as indicated at block 64. In some cases, a separate scheduled control point value may be communicated to the I/O interface for each of the ODU's and/or IDU's in a group of ODU's and/or IDU's. In other cases, a scheduled group control point value may be communicated to the I/O interface, along with an identifier that identifies each of the ODU's and/or IDU's that correspond to the scheduled group control point value (i.e. identifies each of the ODU's and/or IDU's in the corresponding group of ODU's and/or IDU's).

The method 60 includes receiving at one or more of the at least one controller of the VRF system the one or more scheduled control point values via the I/O interface of the VRF system, as indicated at block 66. The at least one ODU and/or the at least one IDU are controlled in accordance with the one or more scheduled control point values, as indicated at block 68. In some cases, the method 60 may include a mobile device allowing a user to define one or more of the two or more groups of ODU's and/or IDU's of the VRF system via a user interface of the mobile device, as indicated at block 70. In some cases, the mobile device may communicate the one or more defined groups for use by the schedule engine to identify the corresponding group programmable schedules, as indicated at block 72.

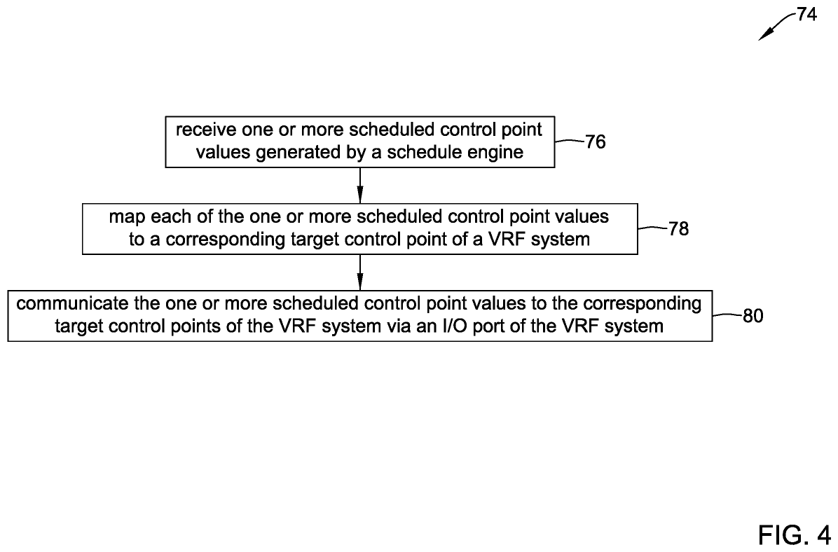

FIG. 4 is a flow diagram showing an illustrative series of steps 74 that may be carried out by one or more processors when the one or more processors execute executable instructions that are stored on a non-transitory, computer readable medium. The one or more processors may be caused to receive one or more scheduled control point values generated by a schedule engine, as indicated at block 76. The one or more processors may be caused to map each of the one or more scheduled control point values to a corresponding target control point of a VRF system, as indicated at block 78. The one or more processors may be caused to communicate the one or more scheduled control point values to the corresponding target control points of the VRF system via an I/O port of the VRF system, as indicated at block 80. In some cases, the one or more processors may be part of the gateway and/or part of the VRF system, but this is not required.

FIG. 5 is a schematic block diagram of an illustrative diagram 120 of a SAMBA integration. VRF systems including mechanical equipment, controllers, sensors and actuators may be offered by OEMs. A VRF system may contain one outdoor unit (ODU) and several indoor units (IDUs). The OEMs may expose some pre-defined control parameters of IDUs and/or ODUs using an I/O interface, such as an I/O interface operating in accordance with the Modbus™ protocol. The term “protocol” may refer to Modbus herein unless indicated otherwise. However, it is contemplated that any suitable communication protocol may be used (e.g. Bacnet, TCIP, etc.). In the example, a Modbus card or device may be connected to multiple IDUs and ODUs controllers. The number of ODUs and IDUs that are part of a particular VRF will often depend on the installation, and may be configurable through tools provided by the OEM.

In one example, a gateway (e.g., a Honeywell Beats™ gateway) is configured to communicate over a Modbus interface. The gateway may have an ethernet port that can be used to connect to the Internet (i.e., wired). Also, the gateway may have two or more RS485 ports out of which a first RS485 channel is reserved for Modbus communication. A mobile app (e.g., a Honeywell Connect Mobile™, a deploy app) may be used to configure the gateway, Modbus devices and all or any IDUs and/or ODUs of the VRF system, and to enable remote monitoring. The gateway may come with a default Wi-Fi access point and the mobile app may connect to the Wi-Fi access point of the gateway. The term “app” may refer to “mobile app” herein unless indicated otherwise.

Configuration in the mobile app may be noted. With a mobile app, a user may add a gateway and configure its first RS-485 channel as a Modbus interface. The mobile app may provide default properties of the Modbus interface and allow a user to customize the properties, e.g., stop bits, transmission mode, and so forth. The mobile app may be connected to the gateway's Wi-Fi™ access point and map the physical gateway with a logical gateway by getting a serial number from the gateway and associating it in the mobile app. The resulting configuration may then be downloaded/pushed from the mobile app to the gateway so that the gateway is aware of the Modbus channel details under it. The Modbus device may have details like the device address, name, and model that can be set in the mobile app.

The mobile app may provide a way to add a Modbus device under a selected gateway. If the user adds the Modbus device first, without configuring the Modbus channel in the gateway, the mobile app may automatically configure a gateway's RS 485 channel one (1) as a Modbus channel and let the user configure its properties, such as stop bits, a transmission mode, and so on. A description of a solution may be indicated. Modbus device details like a device address, name, and model may be set in the mobile app. The mobile app may provide a step-by-step workflow guide to add an IDU and ODU as an equipment's insides of each Modbus device.

The mobile app may have a workflow to prompt a user to enter a base address for each type of Modbus point. Example points may include a discrete input, input register, holding register, and a coil for a given IDU or ODU. Given these details, the mobile app may automatically calculate the actual address of these points as it knows the offset for each point through templates that correspond to the particular VRF system.

The mobile app may establish an automatic Modbus binding or point sharing from each scheduled control point value to corresponding target control points of the IDU and ODU of the VRF system. The binding or point sharing may be transferred to the gateway. The mobile app may also establish a cloud binding for each point so that when a point is commanded/read from the cloud/remote supervisor, it can identify which Modbus register of the I/O interface of the VRF system to command/read. Also, the mobile app may provide a way to establish point sharing between systems. For example, if a fire input has to be used to control the VRF system between on/off, a user may establish point sharing between a fire input point (from another controller in the same site) to an ODU and/or IDU system enable point.

The mobile app may synchronize the model data to a cloud against that site. A supervisor application may fetch this information from the cloud to enable remote monitoring and control of the VRF system, via the gateway and I/O interface of the VRF system. The supervisor may be a web application that can be used by building operators on a day-to-day basis to monitor, diagnose and/or control the VRF system(s).

The gateway may repeatedly poll the point values of the I/O Interface of the VRF system, and send them as telemetry data to the cloud. The supervisor may use this telemetry data and display the VRF monitoring points live values. Also, the supervisor may command a point value, which in turn goes via the cloud, the gateway and to the I/O interface of the VRF system. The command may change a control point value of the VRF system.

The system may provide an approach for enabling remote monitoring, controlling and diagnosis of a VRF system via an I/O interface (e.g. Modbus interface) of the VRF system using a mobile app and a gateway. It allows integrating VRF systems with other systems of a building and/or an overall BMS system for seamless interoperability by leveraging the I/O interfaces often provided by OEM's of the VRF systems.

In some cases, the mobile app may provide a step-by-step guided workflow to add the IDU and ODU systems as the equipment inside of each VFR system. Based on the type of VFR system or vendor, for example, Bluestar™, the mobile app may store a template corresponding to that make/model from which one can identify target control and/or monitor points of each IDU and/or ODU of the VRF, for example, temp setpoint, fan, swing mode, and so on.

Each template may be designed based on a Modbus specification provided by the vendor. A template may identify predetermined points that are made available through the I/O interface of the VFR system including, for example, point name, address offset, type of Modbus register, and so on. The mobile app may have a workflow to prompt the user to enter a base address for each type of point, for examples, one may note discrete input, input register and/or holding register for a given IDU or ODU, and so forth. Given these details, the mobile app may automatically calculate an actual address of each of these points as it knows the offset for each point through the templates provided by the vendor of the VRF system. The mobile app may establish automatic Modbus binding/point sharing between each scheduled control point and the corresponding target control point of each IDU and ODU of the VRF system. This Modbus binding/point sharing may be communicated from the mobile app to the gateway, which can implement the Modbus binding/point sharing during operation.

To illustrate, and with particular reference to FIG. 5, an SMB gateway 121 may have numerous inputs and an outlet 123. Input/Output 122 may be in communication with an I/O interface 142 of VRF system 130. The I/O interface 142 may be a Modbus RTU interface with an OEM defined specification that defines the control and/or monitoring points of the VRF system 130 that are made available. A mobile app 125 may connect to the gateway 121 via a Wi-Fi connection 126. A Wi-Fi/4G output 127 from mobile app 125 may go to an internet 128. An output 129 from a Wi-Fi thermostat 131 and a Wi-Fi output 133 from a smart I/O hub 132 may go to gateway 121. An Ethernet input 134 to gateway 121 may come from a multi tech Lora WAN hub 135. A signal 136 may go from a Netvox sensor 137 to Lora WAN hub 135. An output 138 may go from Internet 128 to a SAMBA cloud services station 139. This is just one example system.

In some cases, the scheduling engine 24 is implemented by the smart I/O hub 132. The smart I/O hub 132 may include one or more wiring terminals for accepting wires that are configured to be connected to one or more building control devices 40 (e.g. fire sensor). The schedule engine 24 may be configured to receive external inputs provided by one or more building control devices via the one or more wiring terminals, and to use one or more of the external inputs in conjunction with the programmable schedule to generate one or more scheduled control point values for one or more of the at least one ODU and/or one or more of the at least one IDU of the VRF system.

The one or more scheduled control point values may be communicated from the smart I/O hub 132 to the gateway 121. In some cases, the gateway 121 maps each of the one or more scheduled control point values received from the smart I/O hub 132 to a corresponding target control point of the I/O interface 142 of the VRF system 130, and communicates the one or more scheduled control point values to the corresponding target control points of the I/O interface 142. In some cases, the gateway 121 maps each of the one or more scheduled control point values received from the controller 22 to the corresponding target control point of one or more of the at least one controller 18 of the VRF system 130 via point sharing. In some cases, the gateway 121 may reference a mapping template that corresponds to the particular VRF system 130. The mapping template may define the predefined points that are made available through the I/O interface 142 of the VRF system 130. In some cases, the scheduling engine 24 is implemented by the gateway 121, the thermostat 131 and/or any other suitable component outside of the VRF system 130.

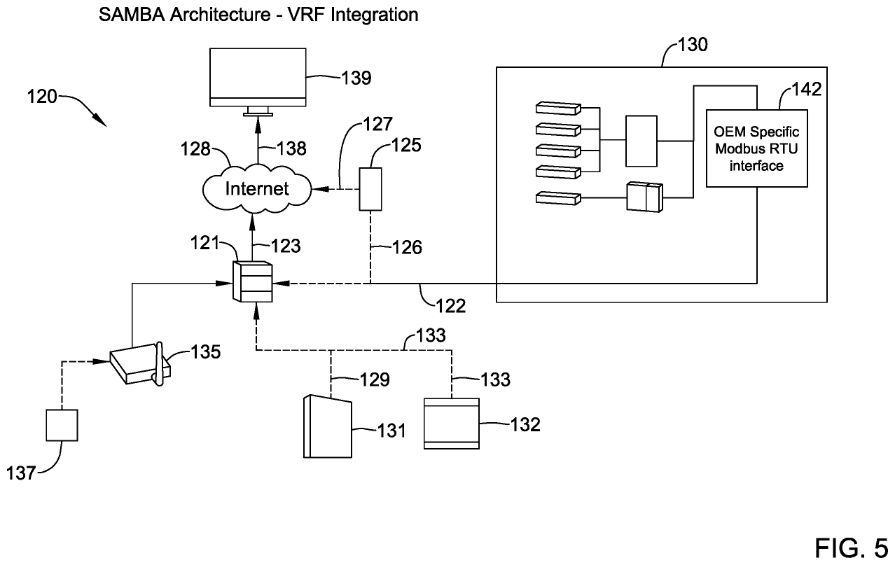

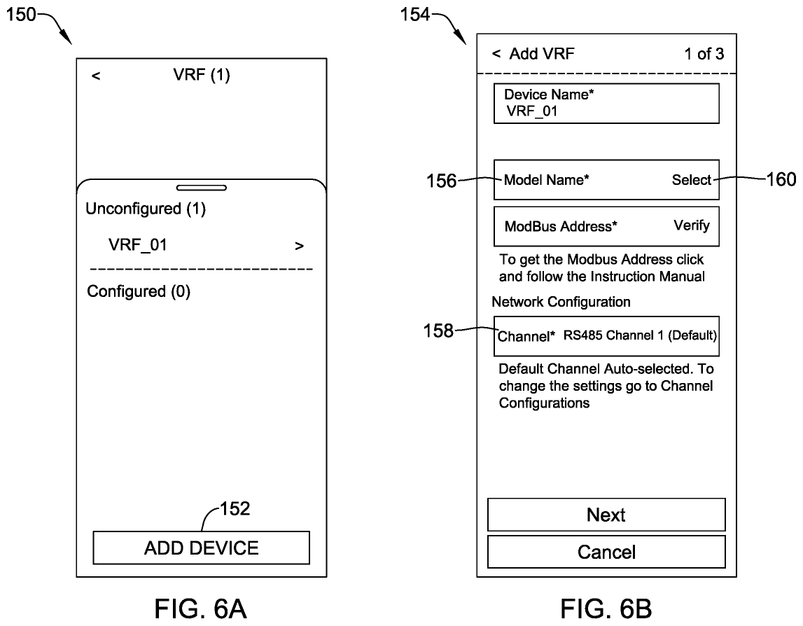

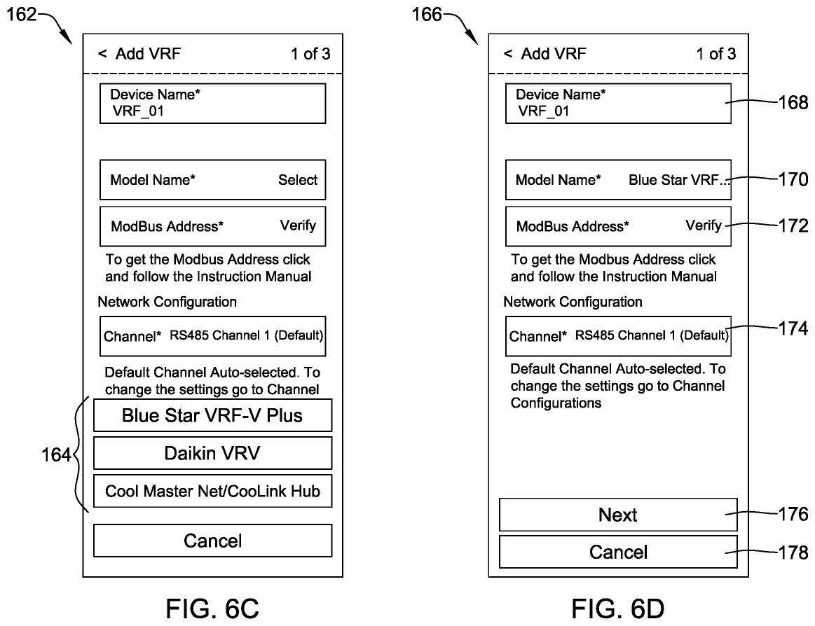

FIGS. 6A through 6D are screen captures showing an illustrative workflow for adding a VRF system via the mobile app. In FIG. 6A, a screen 150 provides a user with the ability to add a VRF device. As shown, the screen 150 includes an ADD DEVICE button 152. Pressing the ADD DEVICE button 152 may cause the mobile device 30 to display a screen 154, as shown in FIG. 6B. The screen 154 allows the user to select a particular model, as indicated at box 156 and to configure the network configuration, as indicated at box 158. The box 156 includes a SELECT button 160. Selecting the SELECT button 160 causes a screen 162 to be displayed, as shown in FIG. 6C. The screen 162 includes a listing 164 of specific models to select from. Selecting one of the specific models, in this case “Blue Star VRF-V Plus” on the screen 162 causes a screen 166 to be displayed, as shown in FIG. 6D. The screen 166 includes a number of parameters for the specific model, including the device name as shown in box 168, the model name as shown in box 170, the Modbus address as shown in box 172 and the network configuration as shown in box 174. The screen 166 also includes a NEXT button 176 and a CANCEL button 178.

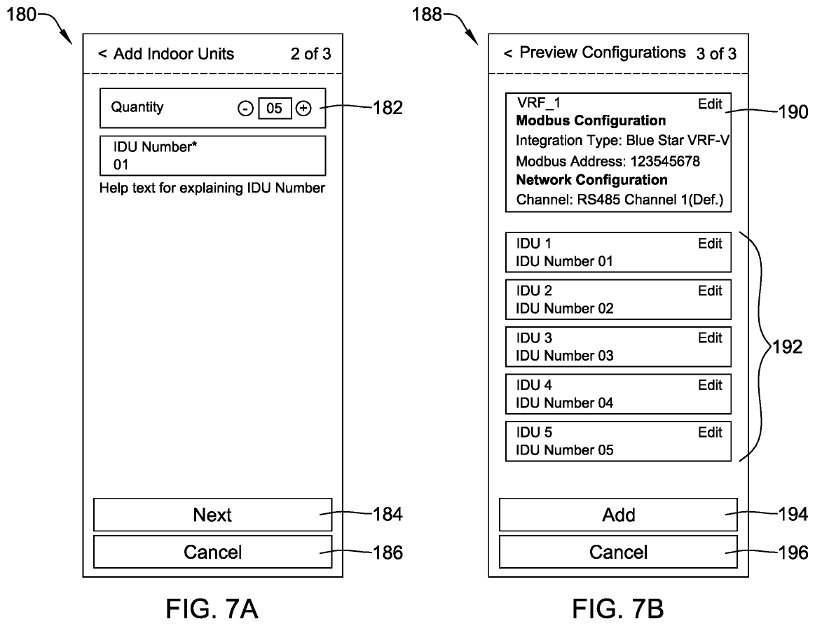

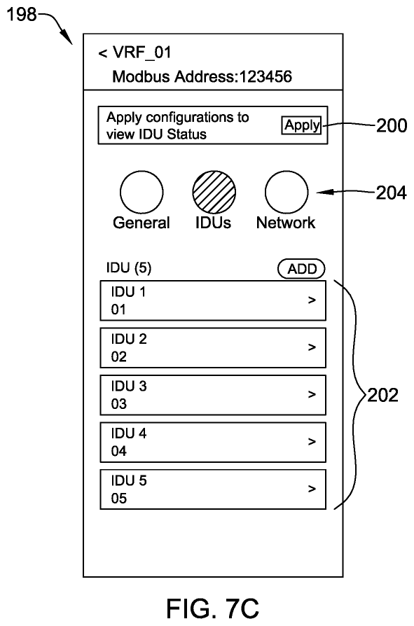

FIGS. 7A through 7C are screen captures showing an illustrative workflow for adding bulk IDUs of an added VRF system via the mobile app. FIG. 7A shows a screen 180 that allows a user to add IDUs in bulk. In some cases, the screen 180 may include a counter 182 that allows the user to indicate how many IDUs they wish to add. The screen 180 includes a NEXT button 184 and a CANCEL button 186. Selecting the NEXT button 184 causes a screen 188 to be displayed, as shown in FIG. 7B. The screen 188 includes an editable box 190 that provides identifying information for the VRF system. The screen 188 also includes a listing 192 of IDUs that are to be added. The screen 188 also includes an ADD button 194 and a CANCEL button 196. Selecting the ADD button 194 causes a screen 198 to be displayed, as shown in FIG. 7C. The screen 198 includes an APPLY button 200 that allows the user to apply configurations to the IDUs. A listing 202 shows each of the IDUs that will be configured. The screen 198 also includes a menu bar 204. In some cases, the IDU's are manually added, while in other cases the IDUs are automatically discovered by querying the VRF system via the I/O interface of the VRF system, and then added.

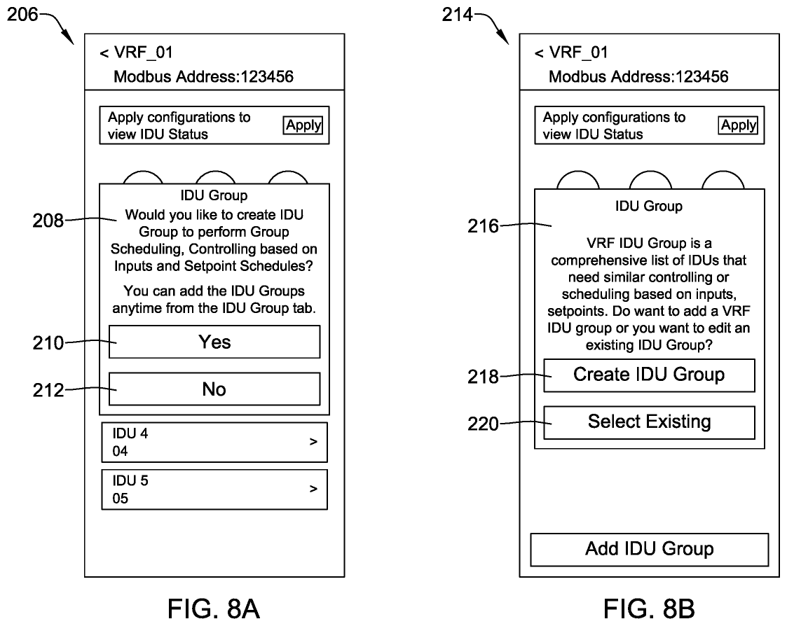

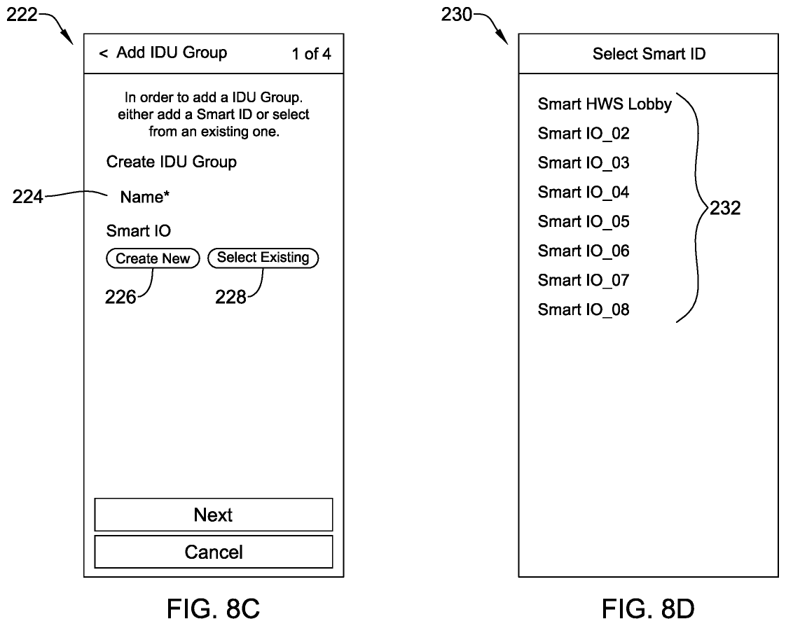

FIGS. 8A through 8D are screen captures showing an illustrative workflow for creating groups for IDUs via the mobile app. FIG. 8A shows a screen 206 including a pop-up screen 208 that asks the user if they wish to create an IDU group. The pop-up screen 208 includes a YES button 210 and a NO button 212. Selecting the YES button 210 causes a screen 214 to be displayed, as shown in FIG. 8B. The screen 214 includes a pop-up screen 216. The pop-up screen 216 asks the user if they wish to create an IDU group or if they wish to edit an existing IDU group. To that end, the pop-up screen 216 includes a CREATE IDU GROUP button 218 and a SELECT EXISTING button 220. Selecting the CREATE IDU GROUP button 218 causes a screen 222 to be displayed, as shown in FIG. 8C. The screen 222 includes a box 224 where the user can provide a name for the IDU group to be created. The screen 222 also includes a CREATE NEW button 226 that may be used to provide details regarding a particular smart IO controller (e.g. smart I/O hub 132) to host the scheduling engine, and a SELECT EXISTING button 228 that may be used to select an existing smart IO controller to host the scheduling engine. Selecting the SELECT EXISTING button 228 causes a screen 230 to be displayed, as shown in FIG. 8D. The screen 230 includes a listing 232 of selectable existing smart IO controllers for the user to choose from.

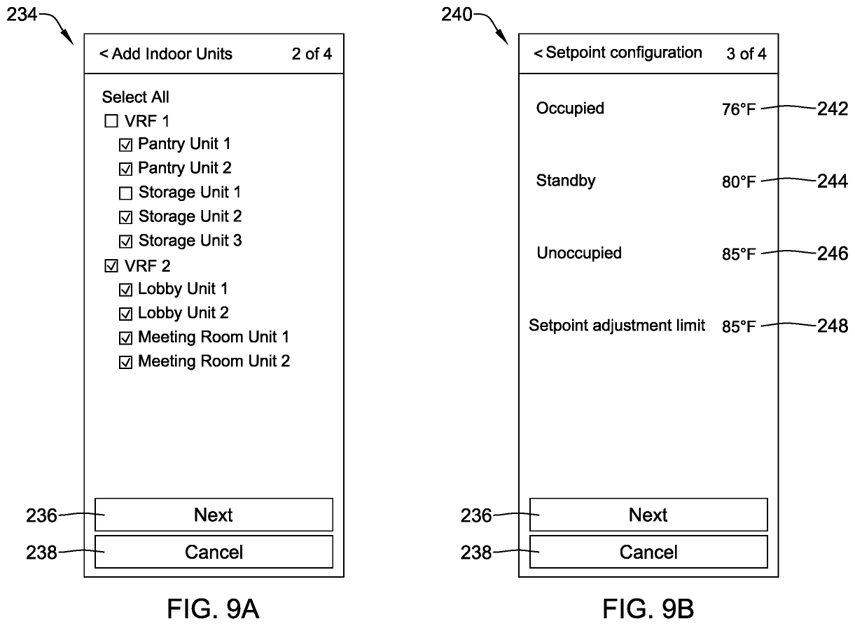

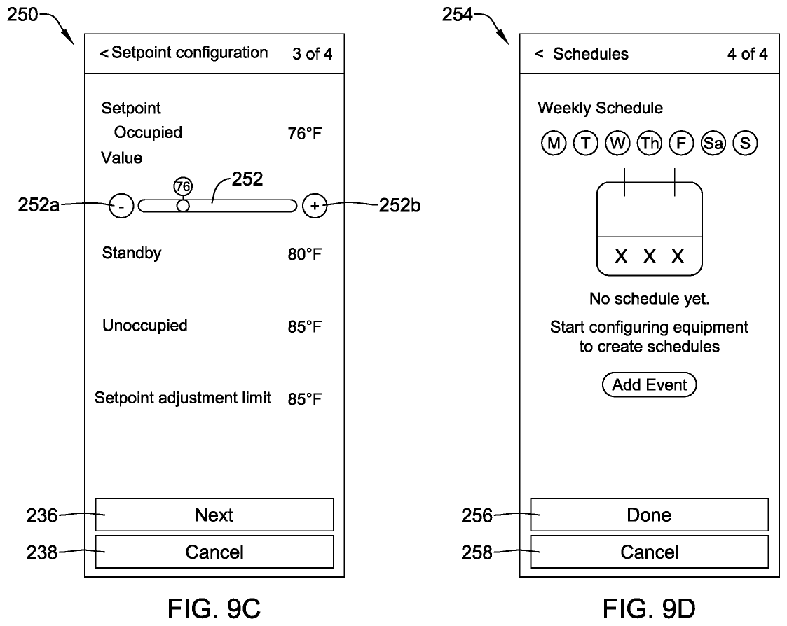

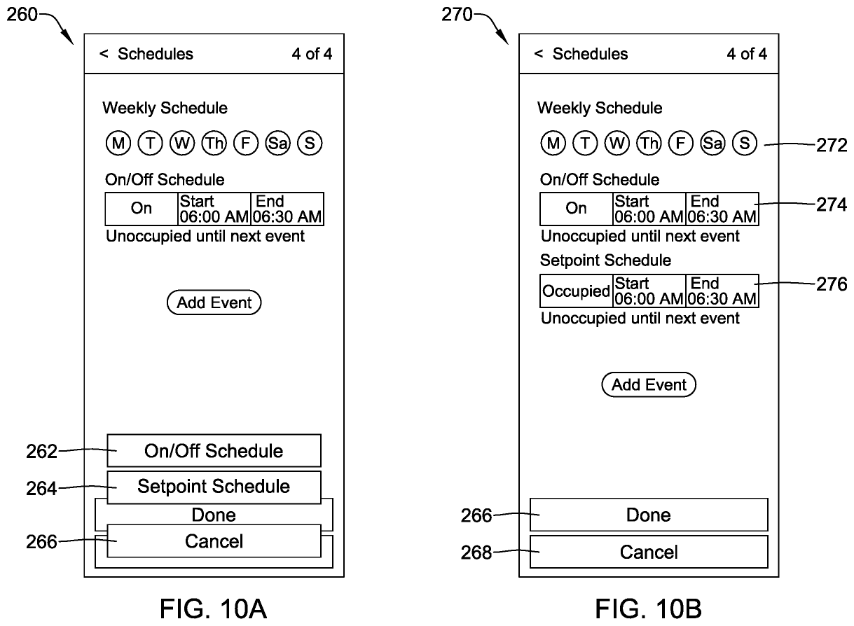

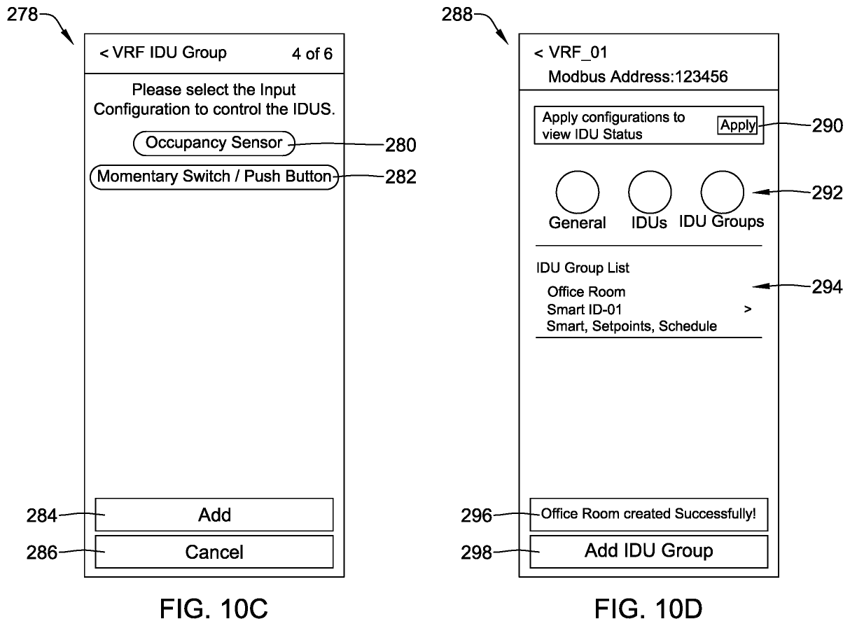

FIGS. 9A through 9D are screen captures showing an illustrative workflow for adding IDUs to groups and setting setpoints and schedules for the IDSs via the mobile app. FIG. 9A shows a screen 234 that includes a listing of several VRFs, and the IDUs corresponding to each of those VRFs. As shown, the screen 234 shows a VRF 1, with a listing of IDUs for VRF 1, and a VRF 2, with a listing of IDUs for VRF 2. It can be seen that some IDUs are selected and some are not. The screen 234 includes a NEXT button 236 and a CANCEL button 238. Pressing the NEXT button 236 causes a screen 240 to be displayed, as shown in FIG. 9B. The screen 240 allows the user to make setpoint configurations, such as for example, an occupied temperature setpoint 242, a standby temperature setpoint 244, an unoccupied temperature setpoint 246 and an adjustment limit 248. Selecting the NEXT button 236 on screen 240 causes a screen 250 to be displayed, as shown in FIG. 9C. As shown, the screen 250 allows the user to edit the occupied temperature setpoint, providing a scale 252 including a minus button 252a and a plus button 252b that may be used to increase or decrease the occupied temperature setpoint 242. Pressing the NEXT button 236 on screen 250 causes a screen 254 to be displayed, as shown in FIG. 9D. The screen 254 allows the user to enter a schedule if they desire, as further described with respect to FIGS. 10A through 10D. The screen 254 includes a DONE button 256 and a CANCEL button 258. The resulting configuration settings will be applied to the IDUs selected in FIG. 9A.

FIGS. 10A through 10D are screen captures showing an illustrative workflow for scheduling VRF IDU groups via the mobile app. FIG. 10A shows a screen 260 that may be used for setting schedules. The screen 260 includes an On/Off schedule button 262, a Setpoint schedule button 264, a DONE button 266 and a CANCEL button 268. Selecting the Setpoint schedule button 264 causes a screen 270 to be displayed, as shown in FIG. 10B. The screen 270 includes a weekly calendar 272, and On/Off schedule bar 274 and a corresponding Setpoint schedule bar 276. FIG. 10C shows a screen 278 that includes an Occupancy Sensor button 280 that may be selected to indicate that an occupancy sensor may be used to control the IDUs and a Momentary Switch button 282 that may be selected to indicate that a momentary switch may be used to control the IDUs. The screen 278 includes an ADD button 284 and a CANCEL button 286. FIG. 10D shows a screen 288 including an APPLY button 290 that may be used to apply a configuration, a menu bar 292, an con 294 showing the newly added “Office Room” IDU group, a confirmation message 296 and an ADD IDU GROUP button 298.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A scheduling system for controlling a Variable Refrigerant Flow (VRF) system in accordance with a programmable schedule, wherein the VRF system includes at least one Outdoor Unit (ODU), at least one Indoor Unit (IDU), at least one controller for controlling the at least one ODU and the at least one IDU, and an I/O interface, the scheduling system comprising:
a controller executing a schedule engine, the schedule engine configured to generate one or more scheduled control point values for one or more of the at least one ODU and/or one or more of the at least one IDU of the VRF system in accordance with the programmable schedule;
a gateway configured to provide a first communication channel between the controller and the I/O interface of the VRF system;
the controller configured to communicate the one or more scheduled control point values to the I/O interface of the VRF system via the gateway; and
wherein one or more of the at least one controller of the VRF system receives the one or more scheduled control point values via the I/O interface of the VRF system and controls the at least one ODU and/or the at least one IDU in accordance with the one or more scheduled control point values.

2. The scheduling system of claim 1, wherein the gateway maps each of the one or more scheduled control point values received from the controller to a corresponding target control point of one or more of the at least one controller of the VRF system, and communicates the one or more scheduled control point values to the corresponding target control points.

3. The scheduling system of claim 2, wherein the gateway maps each of the one or more scheduled control point values received from the controller to the corresponding target control point of one or more of the at least one controller of the VRF system via point sharing.

4. The scheduling system of claim 3, further comprising a mobile device that includes a user interface, the mobile device is configured to:
receive a selection of the VRF system from a plurality of different VRF systems via the user interface of the mobile device;
generate a mapping between the one or more scheduled control point values generated by the schedule engine to a corresponding target control point of the I/O interface of the selected VRF system; and
communicate the mapping to the gateway.

5. The scheduling system of claim 1, wherein the gateway is configured to establish a second communication channel with a building controller, wherein the building controller includes one or more wiring terminals for accepting wires that are configured to be connected to one or more building control devices, and wherein the building controller houses the controller.

6. The scheduling system of claim 5, wherein the one or more building control devices include one or more of an HVAC component, a lighting component, a fire system component and a sensor.

7. The scheduling system of claim 5, wherein the gateway is configured to establish a third communication channel with a remote supervisor, wherein the third communication channel comprises the Internet, and the gateway is configured to receive from the remote supervisor over the third communication channel changes to the programmable schedule.

8. The scheduling system of claim 1, wherein the schedule engine is configured to generate one or more scheduled group control points values for each of two or more groups of ODU's and/or IDU's of the VRF system in accordance with a corresponding group programmable schedule, wherein at least one of the two or more groups comprise two or more ODU's and/or IDU's of the VRF system.

9. The scheduling system of claim 8, wherein the controller is configured to communicate the one or more scheduled group control point values for each of the ODU's and/or IDU's in each of the groups of ODU's and/or IDU's of the VRF system to the I/O interface of the VRF system via the gateway.

10. The scheduling system of claim 8, further comprising:
a mobile device that includes a user interface, the mobile device is configured allow a user to define one or more of the two or more groups of ODU's and/or IDU's of the VRF system via the user interface of the mobile device, the mobile device further configured to communicate the one or more defined groups for use by the schedule engine to identify the corresponding group programmable schedules.

11. The scheduling system of claim 10, wherein the mobile device is configured to:
allow the user to define a schedule for each of the one or more defined groups via the user interface of the mobile device; and
communicate the defined schedule for each of the one or more defined groups for use by the schedule engine.

12. The scheduling system of claim 1, wherein the schedule engine of the controller is configured to receive external inputs provided by one or more building control devices, and to use one or more of the external inputs in conjunction with the programmable schedule to generate the one or more scheduled control point values for one or more of the at least one ODU and/or one or more of the at least one IDU of the VRF system.

13. The scheduling system of claim 1, wherein the one or more scheduled control point values comprise one or more of:
an ON/OFF control point value; and
a setpoint control point value.

14. The scheduling system of claim 1, wherein the controller is:
housed separate from the gateway; or
housed by the gateway.

15. A method for scheduling a Variable Refrigerant Flow (VRF) system in accordance with a programmable schedule, wherein the VRF system includes at least one Outdoor Unit (ODU), at least one Indoor Unit (IDU), at least one controller for controlling the at least one ODU and the at least one IDU, and an I/O interface, the method comprising:
executing a schedule engine on a controller, the schedule engine generates one or more scheduled control point values for one or more of the at least one ODU and/or one or more of the at least one IDU of the VRF system in accordance with the programmable schedule;
communicating from the controller the one or more scheduled control point values generated by the schedule engine to the I/O interface of the VRF system via a gateway;
receiving at one or more of the at least one controller of the VRF system the one or more scheduled control point values via the I/O interface of the VRF system; and
controlling the at least one ODU and/or the at least one IDU in accordance with the one or more scheduled control point values.

16. The method of claim 15, comprising:
the gateway mapping each of the one or more scheduled control point values received from the controller to a corresponding target control point of one or more of the at least one controller of the VRF system; and
communicating the one or more scheduled control point values to the corresponding target control points.

17. The method of claim 16, wherein the gateway maps each of the one or more scheduled control point values received from the controller to the corresponding target control point of one or more of the at least one controller of the VRF system via point sharing.

18. The method of claim 15, wherein:
the schedule engine generating one or more scheduled group control points values for each of two or more groups of ODU's and/or IDU's of the VRF system in accordance with a corresponding group programmable schedule, wherein at least one of the two or more groups comprise two or more ODU's and/or IDU's of the VRF system; and
the controller communicating the one or more scheduled group control point values for each of the ODU's and/or IDU's in each of the groups of ODU's and/or IDU's of the VRF system to the I/O interface of the VRF system via the gateway.

19. The method of claim 18, comprising:
a mobile device allowing a user to define one or more of the two or more groups of ODU's and/or IDU's of the VRF system via a user interface of the mobile device; and
the mobile device communicating the one or more defined groups for use by the schedule engine to identify the corresponding group programmable schedules.

20. A non-transitory computer readable medium storing instructions that when executed by one or more processors cause the one or more processors to:
receive one or more scheduled control point values generated by a schedule engine;
map each of the one or more scheduled control point values to a corresponding target control point of a VRF system; and
communicate the one or more scheduled control point values to the corresponding target control points of the VRF system via an I/O port of the VRF system.
